(19) United States
(12) Patent Application Publication
(10) Pub. No.: US 2013/0215107 A1
(43) Pub. Date: Aug. 22, 2013

(54) IMAGE PROCESSING APPARATUS, IMAGE PROCESSING METHOD, AND PROGRAM

(71) Applicant: Sony Corporation, (US)

(72) Inventors: Seiji Kimura, Chiba (JP); Goh Kobayashi, Tokyo (JP)

(73) Assignee: Sony Corporation, Tokyo (JP)

(21) Appl. No.: 13/761,910

(22) Filed: Feb. 7, 2013

(30) Foreign Application Priority Data
Feb. 17, 2012 (JP) 2012-033125

(51) Int. Cl. G06T 15/00

(52) U.S. Cl. CPC G06T 15/00
USPC 345/419

(57) ABSTRACT

There is provided an image processing apparatus including a depth map information estimation unit configured to estimate a depth in region units of a two-dimensional image and generate depth map information in which a depth estimation value in region units of a two-dimensional image is set, a reliability information generation unit configured to generate a depth map information reliability by determining a reliability of the depth value set in the depth map information, a depth map information correction unit configured to generate corrected depth map information by correcting the depth map information based on the depth map information reliability, and a 3D image generation unit configured to generate from the two-dimensional image an image for a left eye (L image) and an image for a right eye (R image) to be applied in a three-dimensional image display by applying the corrected depth map information.

### BACKGROUND

The present disclosure relates to an image processing apparatus, an image processing method, and a program. More specifically, the present disclosure relates to an image processing apparatus, an image processing method, and a program that generates a three-dimensional image (3D image) to be stereoscopically viewed (three-dimensionally viewed).

A stereoscopic image (three-dimensional image) that can be viewed as a three-dimensional image having depth is configured of a combination of two images of an image for a left eye (L image) and an image for a right eye (R image), which are images from different viewing points. In order to obtain the images from the two viewing points, that is, binocular parallax images, two imaging apparatuses are arranged at left and right sides to be apart from each other and capture images.

A pair of captured stereoscopic images are configured using a pair of images including an image for a left eye (L image) to be captured by the left imaging apparatus and observed by the left eye and an image for a right eye (R image) to be captured by the right imaging apparatus and observed by the right eye.

The pair of stereoscopic images that are configured using the pair of images including the image for the left eye (L image) and the image for the right eye (R image) are displayed on a display apparatus that can separate the image for the left eye and the image for the right eye to be viewed by the left eye and the right eye of an observer, such that the observer can recognize the images as a three-dimensional image.

On the other hand, various proposals have also been made concerning configurations for generating a three-dimensional (3D) image as a binocular parallax image formed from an image for a left eye and an image for a right eye corresponding to a stereoscopic image (three-dimensional image) utilizing a normal two-dimensional (2D) image captured from a single viewpoint.

These proposals have been made to respond to the current situation in which, although liquid crystal displays and plasma displays (PDP) have recently become widespread as display devices capable of three-dimensional (3D) display, there is a lack of 3D content for display on such 3D display devices, and are expected to make up for the lack of 3D content based on technology that pseudo-converts ordinary two-dimensional (2D) image signals into three-dimensional (3D) image signals (hereinafter, “2D to 3D conversion”).

In 2D to 3D conversion, depth information needs to be estimated from ordinary 2D image signals. For example, in JP 10-051812A, as a clue about depth, depth information is estimated based on an integrated value of a high frequency component in addition to the luminance contrast, a luminance integrated value, and a saturation integrated value.

For example, for depth estimation that utilizes an integrated value of a high-frequency component, processing is executed that estimates that the depth is nearer the higher the high frequency component energy is. Therefore, it inevitably follows that the higher the contrast of a region including a high frequency component, the closer the depth that is estimated. Consequently, an edge portion with a large contrast, such as nightscape neon, tend to jump out too near. On the other hand, portions with comparatively low contrast, such as animal coats and the wrinkles on people's skin, which are in-focus by the camera, are estimated to be further away, so that when viewed in 3D, an unnatural sense of depth may be felt.

Further, when estimating depth by combining with other clues, processing is executed for performing a weighted addition of a plurality of depth estimation values based on information about luminance, saturation and the like. However, in such processing, currently the weighting determination relies on experience, so that precise control that is based on the nature of the image information, for example, is not realized.

In depth estimation processing based on such processing, depending on the scene, side effects can occur, such as a feeling of unease at the sense of depth.

In addition, in “2D to 3D conversion based on edge defocus and segmentation”, Ge Guo, Nan Zhang, Longshe Huo, Wen Gao: ICASSP 2008, although depth map information for a scene having a shallow depth of field was successfully determined based on defocus analysis of an edge portion using wavelets, nothing at all is mentioned about other types of scene.

### SUMMARY

According to an embodiment of the present disclosure, provided are an image processing apparatus, an image processing method, and a program that realizes image conversion in which an unnatural feeling of depth is suppressed in processing for pseudo-converting ordinary two-dimensional (2D) image signals into three-dimensional (3D) image signals.

For example, according to an embodiment of the present disclosure, a more precise depth estimation is realized for depth estimation that is based on frequency analysis of an image.

In previous depth estimation technology based on frequency analysis, as described above, since a region is estimated as being nearer the greater the high frequency component is, namely, the higher the contrast of a region including a high frequency, edge portions of nightscape neon and the like tend to jump out too near.

On the other hand, portions with comparatively low contrast, such as animal coats and the wrinkles on people's skin, which are in-focus by the camera, are estimated to be further away, so that when viewed in 3D, an unnatural sense of depth may be felt.

In previous depth estimation technology based on frequency analysis, a good estimation result can generally be obtained for scenes having a shallow depth of field (a scene in which a foreground object is in-focus and the background is out of focus). However, for other scenes (e.g., a pan focus scene with a deep depth of field), the likelihood of mistakenly estimating the depth increases. A 3D image generated using this result suffers from the problem that an unnatural sense of depth is produced.

For example, the configuration according to an embodiment of the present disclosure realizes 2D to 3D image conversion processing that suppresses an unnatural sense of depth by performing depth estimation processing using frequency analysis, which is not easily affected by contrast, determining whether the estimation result for the scene has a high reliability (e.g., a scene having a shallow depth of field), and performing processing based on the determination result.

According to a first aspect of the present disclosure, there is provided an image processing apparatus including a depth map information estimation unit configured to estimate a depth in region units of a two-dimensional image and generate depth map information in which a depth estimation value in region units of a two-dimensional image is set, a reliability information generation unit configured to generate a depth map information reliability by determining a reliability of the depth value set in the depth map information, a depth map information correction unit configured to generate corrected depth map information by correcting the depth map information based on the depth map information reliability and a 3D image generation unit configured to generate from the two-dimensional image an image for a left eye (L image) and an image for a right eye (R image) to be applied in a three-dimensional image display by applying the corrected depth map information. The depth map information estimation unit may be configured to calculate a middle-low region component energy share from a middle-low region component energy and an AC component energy in region units by performing a frequency component analysis in region units of the two-dimensional image, and generate depth map information in which a depth estimation value is set based on a value of the calculated middle-low region component energy share.

Further, according to an embodiment of the present disclosure, the depth map information estimation unit may be configured to generate depth map information in which a depth estimation value indicating a deep (far away) position is set for a region in which the middle-low region component energy share is large, and a depth estimation value indicating a near (close) position is set for a region in which the middle-low region component energy share is small.

Further, according to an embodiment of the present disclosure, the depth map information estimation unit may be configured to generate depth map information in which a depth estimation value is set based on a value of the calculated middle-low region component energy share by calculating the middle-low region component energy share from the middle-low region component energy and the AC component energy in region units based on the following formula. Middle-low region component energy share=(Middle-low region component energy)/(AC component energy)

Further, according to an embodiment of the present disclosure, the reliability information generation unit may be configured to generate a statistical information reliability calculated by applying peak position information in a depth information histogram, which is frequency distribution information about depth values in the depth map information.

Further, according to an embodiment of the present disclosure, the reliability information generation unit may be configured to calculate a frequency ratio (MF/PF) between a frequency (PF) of a peak value in a depth information histogram, which is frequency distribution information about depth values in the depth map information, and a frequency (MF) of a local minimum in the depth information histogram, and generate a statistical information reliability based on the frequency ratio (MF/PF).

Further, according to an embodiment of the present disclosure, the reliability information generation unit may be configured to generate a spatial distribution reliability calculated by applying difference information about depth values in predetermined region units of the depth map information.

Further, according to an embodiment of the present disclosure, the reliability information generation unit may be configured to generate a luminance reliability, which is a reliability based on a luminance of the two-dimensional image.

Further, according to an embodiment of the present disclosure, the reliability information generation unit may be configured to generate an external block correspondence reliability by applying an externally-input external block detection signal.

Further, according to an embodiment of the present disclosure, the external block detection signal may be at least one of a noise amount measurement result, a signal band measurement result, a face detection result, a telop detection result, EPG information, camera shooting information, or a motion detection result. And the reliability information generation unit is configured to generate the external block correspondence reliability by applying any of the detection signals.

Further, according to an embodiment of the present disclosure, the depth map information correction unit may be configured to generate corrected depth map information by determining a blend ratio between the depth map information and a fixed depth map that has a fixed value as a depth value based on the depth map information reliability, and executing blend processing between the depth map information and the fixed depth map by applying the determined bland ratio.

Further, according to an embodiment of the present disclosure, the depth map information correction unit may be configured to generate corrected depth map information by executing blend processing which, when the depth map information reliability is high, increases a blend ratio of the depth map information, and when the depth map information reliability is low, decreases a blend ratio of the depth map information.

Further, according to an embodiment of the present disclosure, the depth map information correction unit may be configured to generate corrected depth map information in which a depth value range set in the depth map information is controlled based on the depth map information reliability.

Further, according to an embodiment of the present disclosure, the depth map information correction unit may be configured to generate corrected depth map information by executing a control which, when the depth map information reliability is high, decreases a contraction width of a depth value range set in the depth map information, and when the depth map information reliability is low, increases a contraction width of a depth value range set in the depth map information.

Further, according to a second aspect of the present disclosure, there is provided an image processing method executed in an image processing apparatus, the method including estimating with a depth map information estimation unit a depth in region units of a two-dimensional image and generating depth map information in which a depth estimation value in region units of a two-dimensional image is set, generating with a reliability information generation unit a depth map information reliability by determining a reliability of the depth value set in the depth map f of a two-dimensional image and information, generating with a depth map information correction unit corrected depth map information by correcting the depth map information based on the depth map information reliability, and generating with a 3D image generation unit from the two-dimensional image an image for a left eye (L image) and an image for a right eye (R image) to be applied in a three-dimensional image display by applying the corrected depth map information. In the depth map information estimation step, a middle-low region component energy share is calculated from a middle-low region component energy and an AC component energy in region units by performing a frequency component analysis in region units of the two-dimensional image, and depth map information is generated in which a depth estimation value is set based on a value of the calculated middle-low region component energy share.

Further, according to a third aspect of the present disclosure, there is provided a program which causes an image processing apparatus to execute image processing. The program is configured to estimate in a depth map information estimation unit a depth in region units of a two-dimensional image and generate depth map information in which a depth estimation value in region units of a two-dimensional image is set, generate in a reliability information generation unit a depth map information reliability by determining a reliability of the depth value set in the depth map f of a two-dimensional image and information, generate in a depth map information correction unit corrected depth map information by correcting the depth map information based on the depth map information reliability, and generate in a 3D image generation unit from the two-dimensional image an image for a left eye (L image) and an image for a right eye (R image) to be applied in a three-dimensional image display by applying the corrected depth map information. In the depth map information estimation, a middle-low region component energy share is calculated from a middle-low region component energy and an AC component energy in region units by performing a frequency component analysis in region units of the two-dimensional image, and depth map information is generated in which a depth estimation value is set based on a value of the calculated middle-low region component energy share.

The program according to the present disclosure is recorded in a recording medium and is provided to an information processing apparatus or a computer system that can execute various program codes. By executing the program by a program executing unit on the information processing apparatus or the computer system, processing according to the program is realized.

Other objects, features, and advantages of the present disclosure will be more apparent from the following description taken in conjunction with the embodiments and the accompanying drawings. In the present disclosure, a system has a logical set configuration of a plurality of apparatuses and each apparatus may not be provided in the same casing.

According to the configuration of an embodiment of the present disclosure, an apparatus and method are realized for generating a 3D image that applies a highly precise depth value by performing a high-precision depth estimation from a two-dimensional image.

Specifically, a depth map information estimation unit generates depth map information in which a depth estimation value in region units of a two-dimensional image is set. A reliability of the depth value set in the depth map information is determined. The depth map information is corrected based on the reliability to generate corrected depth map information. An image for a left eye (L image) and an image for a right eye (R image) to be applied in a three-dimensional image display are generated from the two-dimensional image by applying the corrected depth map information. The depth map information estimation unit calculates a middle-low region component energy share from a middle-low region component energy and an AC component energy in region units, and generates depth map information in which a depth estimation value is set based on a value of the calculated middle-low region component energy share.

According to this configuration, an apparatus and method are realized for generating a 3D image that applies a highly precise depth value by performing a high-precision depth estimation from a two-dimensional image.

### BRIEF DESCRIPTION OF THE DRAWINGS

FIG. 1 is a diagram illustrating a configuration example of an image processing apparatus according to the present disclosure;

FIG. 2 is a diagram illustrating a configuration example of a depth map information estimation unit in an image processing apparatus according to the present disclosure;

FIG. 3 is a diagram illustrating processing performed by a depth map information estimation unit in an image processing apparatus according to the present disclosure;

FIG. 4 is a diagram illustrating processing performed by a depth map information estimation unit in an image processing apparatus according to the present disclosure;

FIG. 5 is a diagram illustrating a configuration example of a reliability information generation unit in an image processing apparatus according to the present disclosure;

FIG. 6 is a diagram illustrating an example of the processing performed by a reliability information generation unit in an image processing apparatus according to the present disclosure;

FIG. 7 is a diagram illustrating an example of the processing performed by a reliability information generation unit in an image processing apparatus according to the present disclosure;

FIG. 8 is a diagram illustrating an example of the processing performed by a reliability information generation unit in an image processing apparatus according to the present disclosure;

FIG. 9 is a diagram illustrating an example of the processing performed by a reliability information generation unit in an image processing apparatus according to the present disclosure;

FIG. 10 is a diagram illustrating an example of the processing performed by a reliability information generation unit in an image processing apparatus according to the present disclosure;

FIG. 11 is a diagram illustrating an example of the processing performed by a reliability information generation unit in an image processing apparatus according to the present disclosure;

FIG. 12 is a diagram illustrating an example of the processing performed by a reliability information generation unit in an image processing apparatus according to the present disclosure;

FIG. 13 is a diagram illustrating a configuration example of a depth map information correction unit in an image processing apparatus according to the present disclosure;

FIG. 14 is a diagram illustrating a configuration example of a depth map information correction unit in an image processing apparatus according to the present disclosure; and

FIG. 15 is a diagram illustrating a configuration example of a depth map information correction unit in an image processing apparatus according to the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The image processing apparatus, image processing method, and program according to the present disclosure will now be described in detail with reference to the drawings. The description will be made based on the following items.

1. Outline of the overall configuration and processing of the image processing apparatus according to present disclosure
2. Details of the configuration and processing of the depth map information estimation unit
3. Configuration and processing of the reliability information generation unit
3-1. Statistical information reliability calculation unit processing
3-2. Spatial distribution reliability calculation unit processing
3-3. Luminance reliability calculation unit processing
3-4. External block reliability calculation unit processing
3-5. Reliability integration unit processing
4. Configuration and processing of the depth map information correction unit
5. Processing of the 3D image generation unit
6. Flow and effects of the overall processing of the image processing apparatus
7. Summary of the configuration of the present disclosure

### 1. Outline of the Overall Configuration and Processing of the Image Processing Apparatus According to Present Disclosure

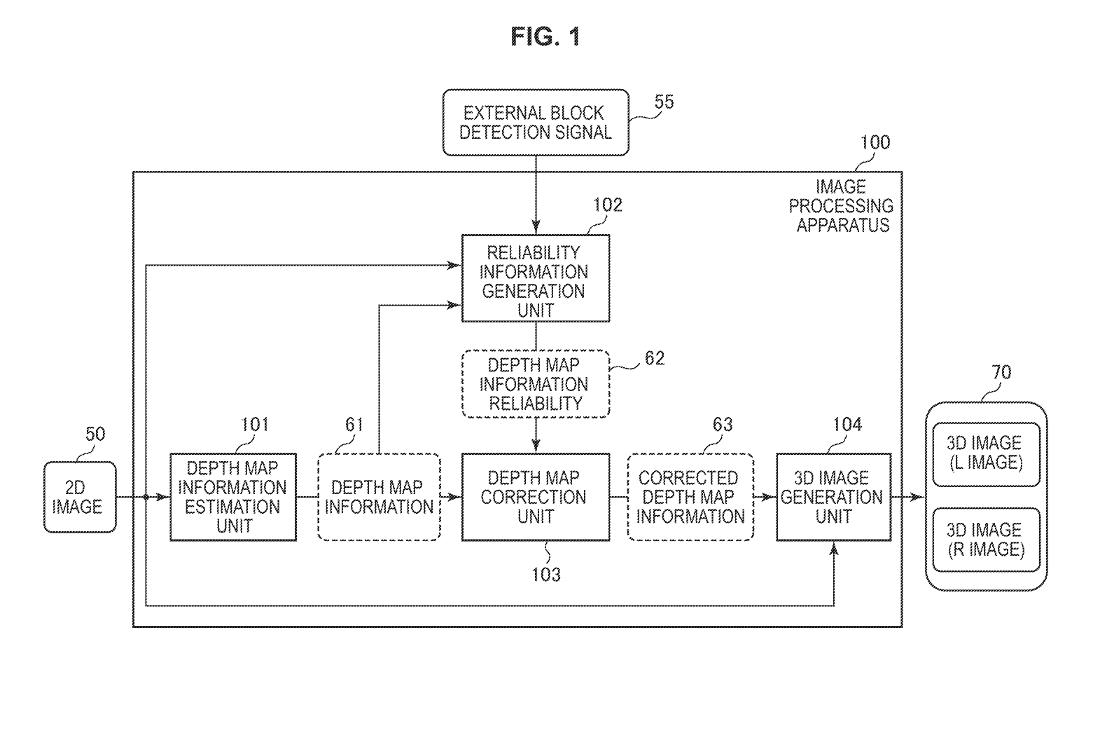

FIG. 1 is a block diagram illustrating an embodiment of a image processing apparatus according to the present disclosure.

The image processing apparatus 100 illustrated in FIG. 1 has a depth map information estimation unit 101, a reliability information generation unit 102, a depth map information correction unit 103, and a 3D image generation unit 104.

The image processing apparatus 100 illustrated in FIG. 1 inputs a two-dimensional (2D) image signal 50, and generates and outputs a 3D image signal 70 that is formed from an image for a left eye (L image) and an image for a right eye (R image), which are images for three-dimensional (3D) image display, based on a single input two-dimensional (2D) image signal 50.

The image processing apparatus 100 according to the present embodiment performs image signal processing that generates a pseudo 3D image signal 70 based on image conversion of a single two-dimensional (2D) image signal 50.

First, the depth map information estimation unit 101 executes depth estimation processing using frequency analysis, which is not easily affected by contrast, on the input 2D image signal 50 to generate depth map information 61.

The reliability information generation unit 102 generates an information reliability 62 that indicates the reliability of the generated depth map information 61.

Further, the depth map information correction unit 103 generates corrected depth map information 63 by correcting the depth map information 61 based on the information reliability 62.

The 3D image generation unit 104 generates a 3D image signal from the input 2D image signal 50 based on the corrected depth map information 63.

The processing performed by each of the constituent units in the image processing apparatus 100 will now be described in more detail.

### 2. Details of the Configuration and Processing of the Depth Map Information Estimation Unit

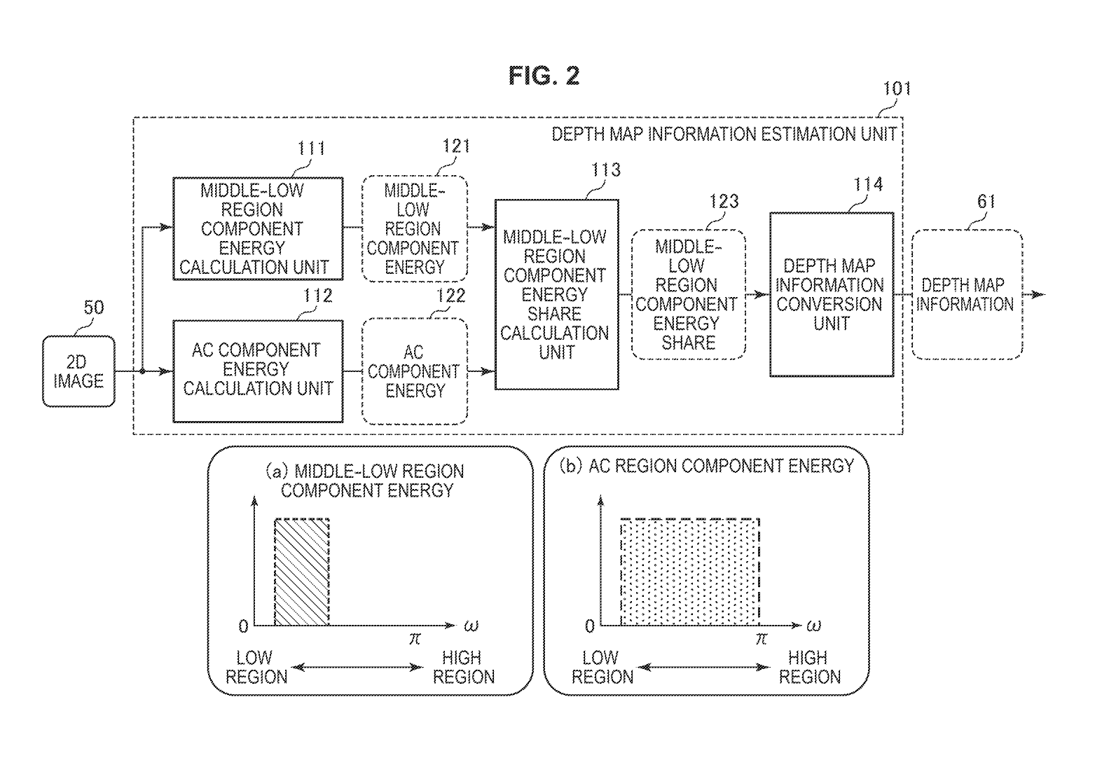

First, the configuration and processing of the depth map information estimation unit 101 in the image processing apparatus 100 illustrated in FIG. 1 will be described in more detail with reference to FIG. 2.

Note that the following description is based on the assumption that the greater the depth map information value is, the nearer the depth is, and the smaller the depth map information value is, the further away the depth is.

For example, when generating depth map information (sometimes also referred to as a depth map) in which a depth value is represented as luminance information, a luminance value from 0 to 255, for example, is set based on the depth in terms of pixel units.

The pixel values are set at a value between 255 (bright) to 0 (dark) based on whether the depth is near (close) to deep (far away).

Thus, the depth map information has a value that indicates depth in terms of the pixel units forming the image.

FIG. 2 illustrates a configuration example of the depth map information estimation unit 101 in the image processing apparatus 100 according to the present disclosure.

A middle-low region component energy calculation unit 111 calculates a middle-low region component energy 121 corresponding to the hatched portion in FIG. 2(a) for the 2D image signal 50 input to the depth map information estimation unit 101 using a band pass filter that has a filter characteristic in which a middle-low region like that illustrated by the hatched portion in FIG. 2(a) is a passband.

This middle-low region component energy 121 calculation processing is executed based on predetermined region units of the input 2D image signal 50, for example pixel units or pixel region units of n×n pixels. The value n may be, for example, 3, 5, 7, 9 etc.

In FIG. 2(a), the horizontal axis represents frequency (normalized to 0 to π), and the vertical axis represents output strength (power).

The middle-low region component energy calculation unit 111 extracts only the middle region component in the 2D image signal 50 by applying a filter that lets the middle-low region of the hatched portion in FIG. 2(a) pass through. This middle-low region component is the frequency region of π/2 or less, for example, in the normalized frequency of 0 to π. This filter setting can also be set by the user who is performing the processing while he/she is observing the image, for example.

The middle-low region component in the 2D image signal 50 is often presumed to be an out-of-focus region.

For example, an edge region where the boundaries of an object are in focus is predominantly a high-region component. In contrast, the middle-low region component is often an out-of-focus region, such as a background object that is not in focus.

On the other hand, an AC component energy calculation unit 112 calculates an AC component energy 122 corresponding to the dotted portion in FIG. 2(b) on signal data having the same range as the filter analysis window of the above middle-low region energy component calculation unit 111, namely, signal data in predetermined region units, for example pixel units or pixel region units of n×n pixels, of the input 2D image signal 50 by removing the DC component energy from the total energy.

This AC component energy 122 may also be generated using a high-pass filter having a wide passband with a filter characteristic corresponding to the dotted portion in FIG. 2(b).

Further, this energy may be the sum of the squares of the filter output or the sum of the absolute values.

Next, a middle-low region component energy share calculation unit 113 determines the ratio of the middle-low region component energy 121 to the AC component energy 122, and outputs the result as a middle-low region component energy share 123. Specifically, the middle-low region component energy share calculation unit 113 calculates the middle-low region component energy share based on the following formula.

Middle-low region component energy share=(Middle-low region component energy)/(AC component energy)

A depth map information conversion unit 114 sets the value of the depth map information 61 to a value that indicates a position that is more distant (further away) the greater (the closer to 1) the input middle-low region component energy share 123 is.

On the other hand, the value of the depth map information 61 is set to a value that indicates a position that is closer (nearer) the smaller (the closer to 0) the middle-low region component energy share 123 is.

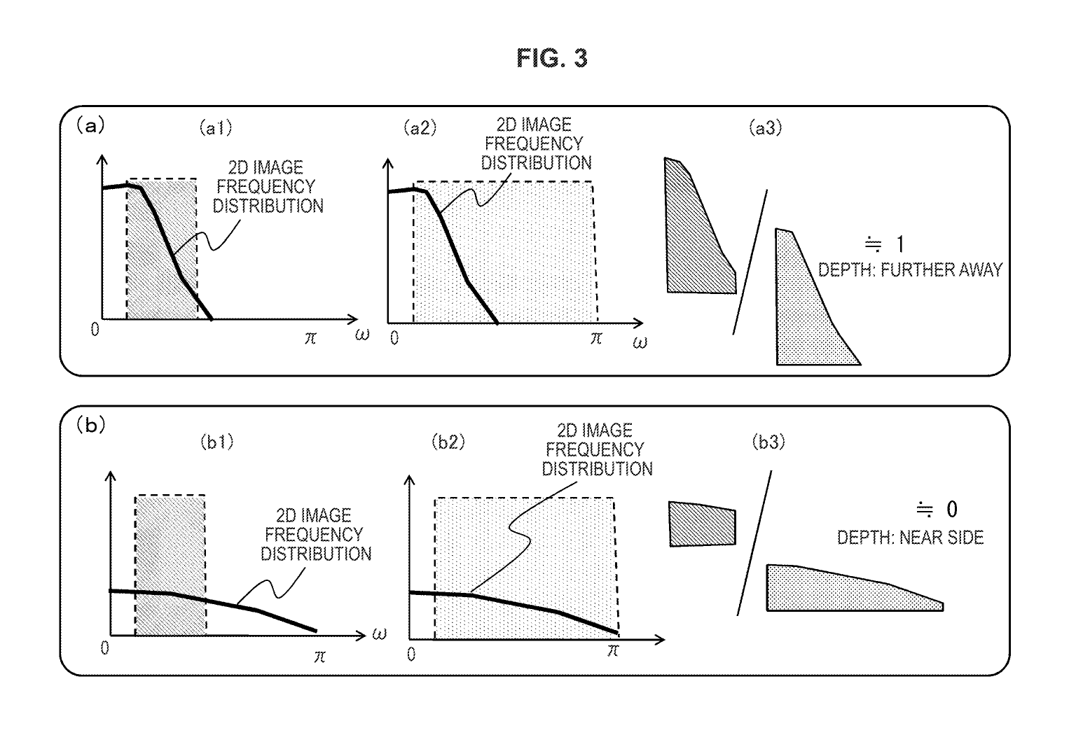

The depth map information conversion processing performed by the depth map information conversion unit 114 will be described with reference to FIG. 3.

FIG. 3 illustrates the following two examples.

(a) Middle-low region component energy share of an image in which middle-low region component energy share is large.
(b) Middle-low region component energy share of an image in which middle-low region component energy share is small.

In FIG. 3(a), the following examples of processing on an image with a large middle-low region component energy share are illustrated.

(a1) Middle-low region component energy extraction processing
(a2) AC component energy extraction processing
(a3) Middle-low region component energy share

The thick lines shown in (a1) and (a2) correspond to the frequency distribution of the processing target region in the image.

As illustrated in (a1) and (a2), the overlapping region between the thick lines representing the frequency distribution of the image and the respective filter region is almost the same. The middle-low region component energy extraction processing executed in (a1) and the AC component energy extraction processing executed in (a2) are both performed at about the same strength (energy level).

Therefore, as illustrated in (a3), the following holds true in the calculation processing of the middle-low region component energy share.

(Middle-low region component energy)/(AC component energy)≈1

Thus, the middle-low region component energy share is about 1.

Specifically, as illustrated in FIG. 3(a), the greater (closer to 1) the middle-low region component energy share 123 is, the higher the ratio exhibited by the middle-low region component in the signal band is. Namely, since an out-of-focus region is shown, the region is determined to be a background out-of-focus portion, so that the depth map information 61 value is set to a value indicating a distant position (further away).

On the other hand, in FIG. 3(a), the following examples of processing on an image with a small middle-low region component energy share are illustrated.

(b1) Middle-low region component energy extraction processing
(b2) AC component energy extraction processing; and
(b3) Middle-low region component energy share.

The thick lines shown in (b1) and (b2) correspond to the frequency distribution of the processing target region in the image.

As illustrated in (b1) and (b2), the overlapping region between the thick lines representing the frequency distribution of the image and the respective filter region is very different. The middle-low region component energy extraction processing executed in (b1) and the AC component energy extraction processing executed in (b2) are performed at very different strengths (energy levels).

Therefore, as illustrated in (b3), the following holds true in the calculation processing of the middle-low region component energy share.

(Middle-low region component energy)/(AC component energy)≈0

Thus, the middle-low region component energy share is a value close to 0.

As illustrated in FIG. 3(b), the smaller (closer to 0) the middle-low region component energy share 123 is, the lower the ratio exhibited by the middle-low region component in the signal band is. Namely, since an in-focus region that includes a high frequency component is shown, the region is determined to be a foreground object portion, so that the depth map information 61 value is set to a value indicating a closer position (near).

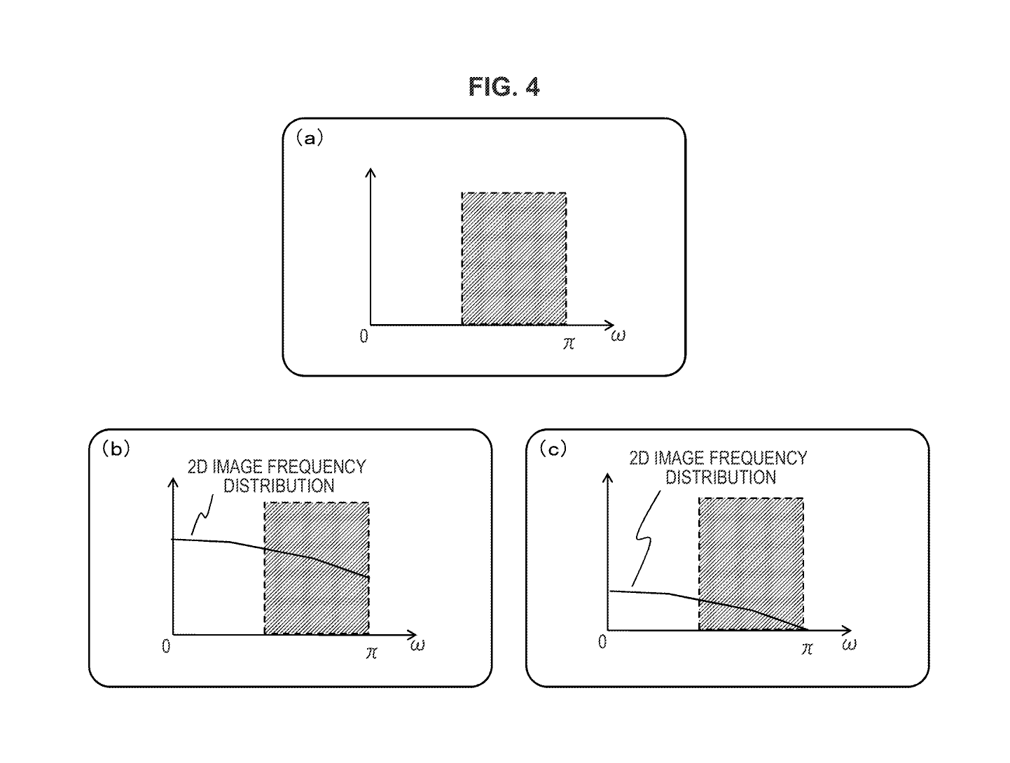

An example of a related art method is to calculate the output energy of a high-pass filter as illustrated in FIG. 4(a), estimate the region determined to have a large high-pass filter output energy to be a near region, and set the value of the depth map information to the near side.

However, a method that relies on a high-pass filter can suffer from the following drawbacks.

For example, for a high-region component with a high contrast (e.g., a nightscape electrical lamp (neon) etc.), for example, as illustrated in FIG. 4(b), the high-pass filter output energy increases. If processing that relies on a high-pass filter is performed on such an image, this image region is determined to be at a position that is too near, so that position information that is too near may be set as the value of the depth map information 61.

On the other hand, for a high-region component with a low contrast (e.g., an animal's coat, the wrinkles on people's skin etc.), as illustrated in FIG. 4(c), the high-pass filter output energy decreases. If processing that relies on a high-pass filter is performed on such an image, this image region is determined to be at a position that is too far away, so that position information that is too far away may be set as the value of the depth map information 61.

In contrast, in the method according to the present disclosure, the depth estimation is performed based on:

(1) the middle-low region component, and
(2) the AC component.

By applying this method, for example, then even for a high-component region with a high contrast like that illustrated in FIG. 4(b), or a low-component region with a high contrast like that illustrated in FIG. 4(c), in either case the calculated value of the middle-low region component energy share, i.e.,

(Middle-low region component energy)/(AC component energy)

is about the same. Therefore, there is a reduced possibility of mistaken depth information being set, as can happen in processing that is reliant on a high-pass filter. Specifically, since the method according to the present disclosure is already less susceptible to the effects of the 2D image picture, problems like those in the related art do not occur.

The depth map information conversion unit 114 generates and outputs the depth map information 61 in which the depth information has been converted based on the above middle-low region component energy share. The depth map information 61 can be output, for example, as a luminance image, which is an image that in which a luminance value is set based on the depth of each pixel, in which

Close depth (near side)=high luminance (high pixel value), and

Far away depth (further away)=low luminance (low pixel value).

### 3. Configuration and Processing of the Reliability Information Generation Unit

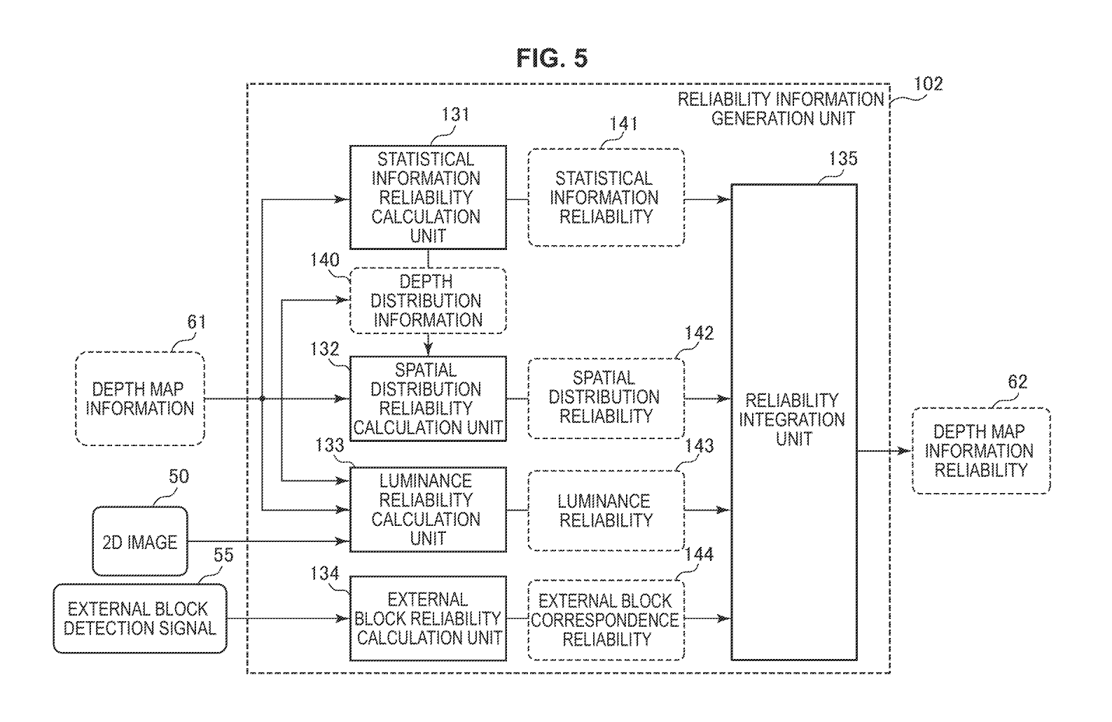

Next, the configuration and processing of the reliability information generation unit 102 in the image processing apparatus 100 illustrated in FIG. 1 will be described with reference to FIG. 5 onwards.

FIG. 5 illustrates a configuration example of the reliability information generation unit 102.

As illustrated in FIG. 5, the reliability information generation unit 102 has a statistical information reliability calculation unit 131, a spatial distribution reliability calculation unit 132, a luminance reliability calculation unit 133, an external block reliability calculation unit 134, and a reliability integration unit 135.

### 3-1. Statistical Information Reliability Calculation Unit Processing

First, the processing performed by the statistical information reliability calculation unit 131 in the reliability information generation unit 102 illustrated in FIG. 5 will be described.

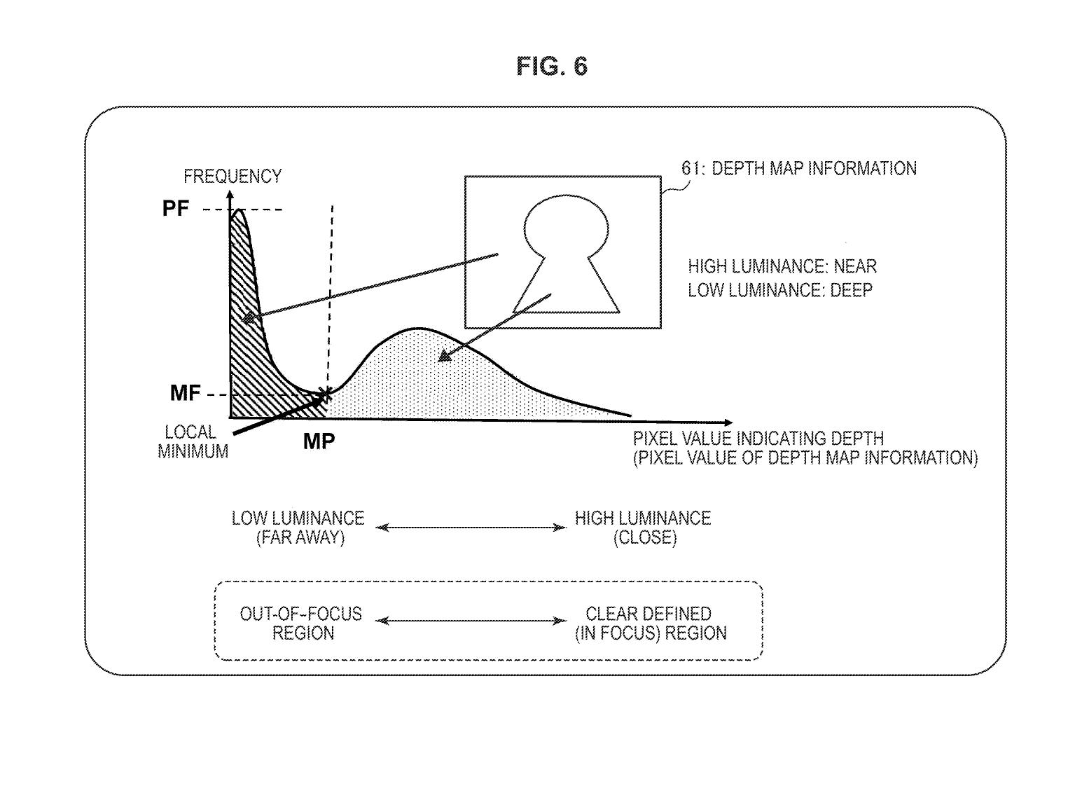

The statistical information reliability calculation unit 131 inputs the depth map information 61 generated by the depth map information estimation unit 101, acquires depth information about the position of each pixel set in the depth map information 61, generates, for example, a depth information histogram like that illustrated in FIG. 6, and determines a frequency peak value PF and a local minimum value MF.

In the depth information histogram illustrated in FIG. 6, the horizontal axis represents the pixel value set in the depth map information 61, and the vertical axis represents frequency (pixel number).

As described above, as the pixel value set in the depth map information 61, a luminance image (=depth map) set in the following manner may be utilized.

Close depth (near side)=high luminance (high pixel value), and

Far away depth (further away)=low luminance (low pixel value).

For example, for a scene captured with a shallow depth of field, such as a typical portrait taken of a person, the background is out of focus and the foreground object is clearly defined. For such a portrait scene, if a histogram is taken of the depth map information 61 output by the depth map information estimation unit 101, as illustrated in FIG. 6, a hill is formed from the data corresponding to the background out-of-focus portion. The top of this hill is often the peak value in the whole histogram.

The frequency of the peak value in the depth information histogram is referred to as PF.

On the other hand, the clearly defined foreground object portion forms another hill in the depth information histogram. Between these two hills a valley, namely, a local minimum, is set.

The frequency of this local minimum is referred to as MF, and the position of the level serving as the local minimum is referred to as MP.

The statistical information reliability calculation unit 131 calculates a ratio (MF/PF) between the histogram peak value frequency (PF) and the histogram local minimum frequency (MF).

Based on this ratio (MF/PF) between the peak and the local minimum in the histogram, a parameter (R_shape) is calculated for calculating a statistical information reliability 141.

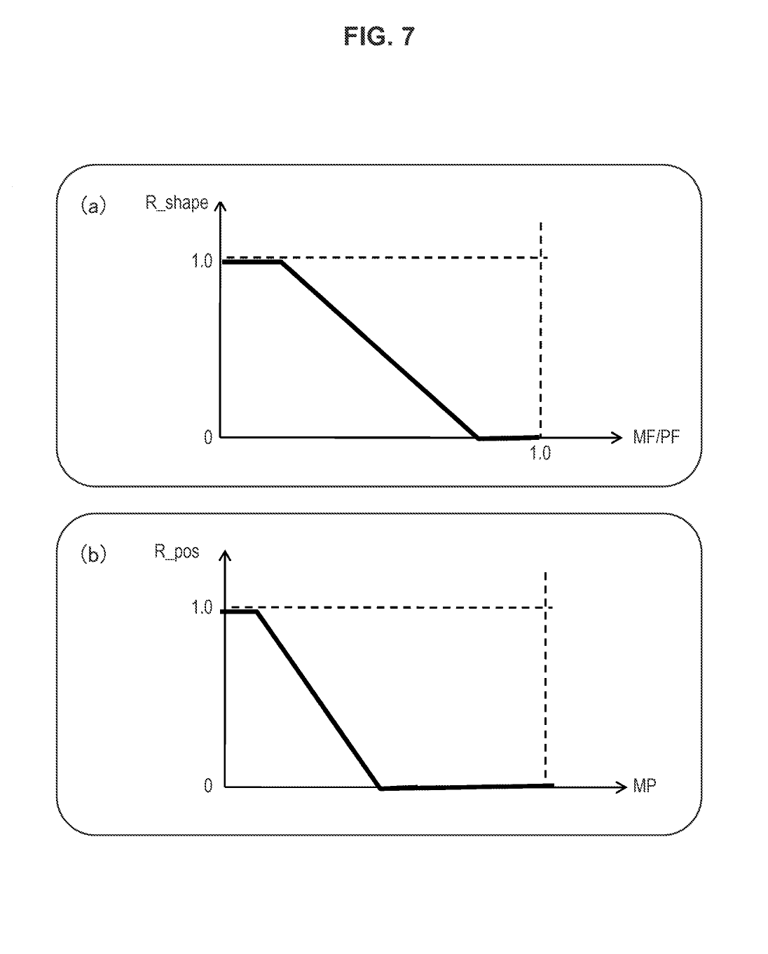

Specifically, like the graph characteristic illustrated in FIG. 7(a), the smaller the value of (MF/PF) is, the greater (closer to 1.0) the reliability (R_shape) based on the steepness of the peak that is set.

Further, the statistical information reliability calculation unit 131 calculates a parameter (R_pos) for calculating the statistical information reliability 141 using a relative position (MP) of the depth value indicating a local minimum in the histogram.

Specifically, like the graph characteristic illustrated in FIG. 7(b), the smaller MF is, the greater the reliability (R_pos) based on the local minimum position that is set.

Using the above two reliability calculation parameters (R_shape and R_pos), the statistical information reliability 141 is calculated and output.

As the specific calculation processing for the statistical information reliability 141, either of these two reliability calculation parameters (R_shape and R_pos) can be set as the statistical information reliability 141, or if both are used, the calculation can also be made using the product of the two, a weighted average and the like.

Further, if there is no local minimum on the right side of the peak value PF hill in the depth information histogram, the statistical information reliability 141 value is set to a small value such as 0.

### 3-2. Spatial Distribution Reliability Calculation Unit Processing

Next, the processing performed by the spatial distribution reliability calculation unit 132 in the reliability information generation unit 102 illustrated in FIG. 5 will be described.

The spatial distribution reliability calculation unit 132 inputs depth distribution information 140 from the statistical information reliability calculation unit 131. The depth distribution information 140 is, for example, analysis information about a depth information map. Specifically, the depth distribution information 140 is the depth information histogram described with reference to FIG. 6.

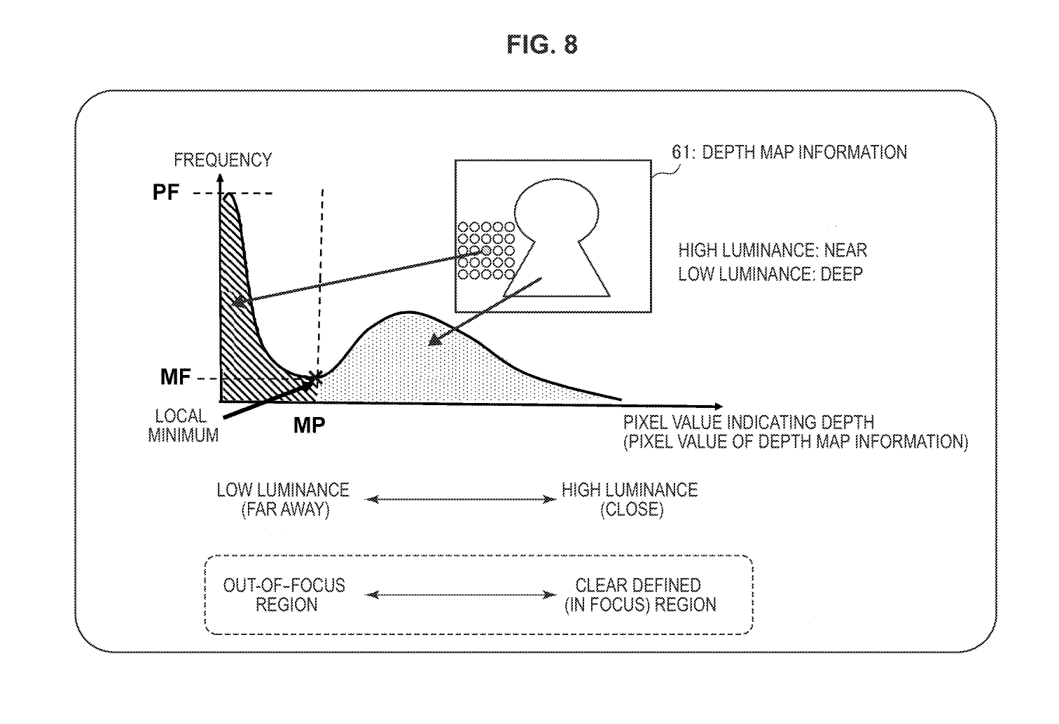

The spatial distribution reliability calculation unit 132 determines whether data in the depth information histogram generated based on the depth map information 61 belongs to the hill on the left side (hatched portion) of the low luminance side or the hill on the right side (dotted portion) for two distributions like those illustrated in FIG. 8.

First, the number of pieces of data belonging to the low luminance side of the depth information histogram, i.e., the hill on the left side (hatched portion), is counted (this value is referred to as NumLowDpth). Next, for each piece of pixel data belonging to the hill on the left side (hatched portion), as illustrated in the image of the depth map information 61 at the upper right of FIG. 8, with each piece of pixel data belonging to the hill on the left side (hatched portion) as a target pixel, the number of pixels in a peripheral pixel region around the target pixel (e.g., a peripheral region of 5×5 pixels) in which the ratio of pixels belonging to the hill on the left side (hatched portion) of the low luminance side in the depth information histogram is, similar to the target pixel, a predetermined ratio or more are counted. This value is referred to as NumUfmDpth.

Specifically, if the state of belonging to the hill on the left side (hatched portion) is represented as LDP, of all the pixels X that are a LDP, the number of pixels X that are included in the ratio of pixels that are LDP in that peripheral pixel region of a predetermined ratio or more is taken as NumUfmDpth.

Further, the ratio (UFM_R) between these two values, NumLowDpth, which is the number of pixels belonging to the low luminance side hill (hatched portion) of the depth information histogram, and NumUfmDpth, which is the number of pixels including peripheral pixels, that belong to the low luminance side hill (hatched portion) at a predetermined ratio or more is calculated. Namely,

UFM_{—}R=NumUfmDpth/NumLowDpth

A spatial distribution reliability 142 is calculated based on this pixel number ratio (UFM_R).

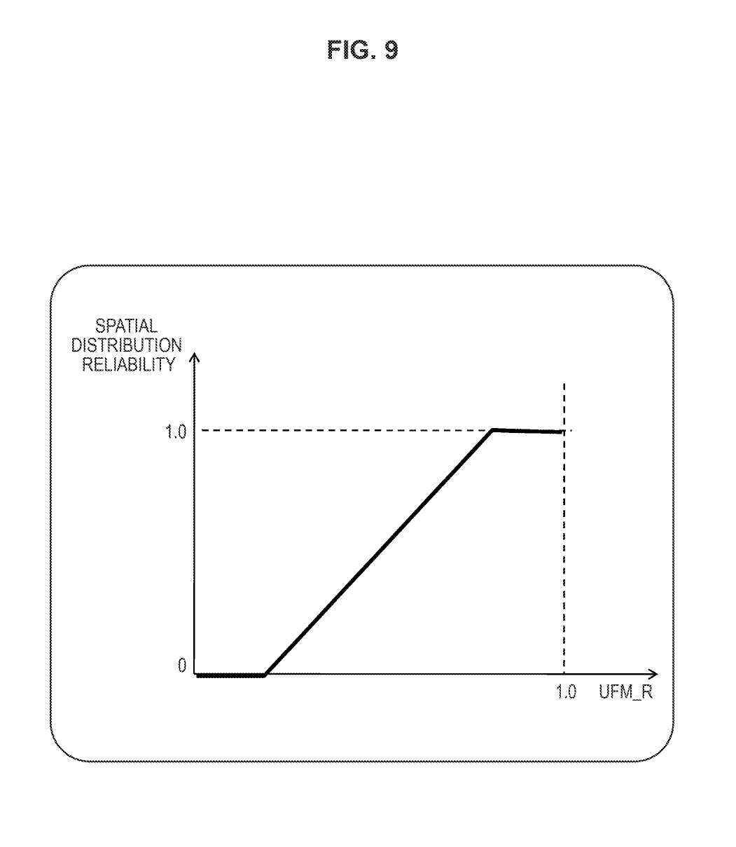

Specifically, like the graph characteristic illustrated in FIG. 9, the greater the UFM_R is, the greater the spatial distribution reliability 142 that is set.

This spatial distribution reliability 142 is such that the distribution belonging to an out-of-focus region like that illustrated in FIG. 8 and the distribution belonging to a clearly defined region have a different value based on whether there is a spatial bias or whether these distributions are present as spatial outliers.

If the distribution belonging to the out-of-focus region and the distribution belonging to the clearly defined region are present as spatial outliers, a determination is made that the data is not an image like a portrait, and that it has been affected by noise. In such a region, the spatial distribution reliability 142 value is set as a low value. Based on this value, processing can be performed that makes the side effects of the 3D image in which such a scene has been converted stand out less.

### 3-3. Luminance Reliability Calculation Unit Processing

Next, the processing performed by a luminance reliability calculation unit 133 in the reliability information generation unit 102 illustrated in FIG. 5 will be described.

As illustrated in FIG. 5, the luminance reliability calculation unit 133 inputs the 2D image signal 50, the depth map information 61, and the depth distribution information 140 from the statistical information reliability calculation unit 131.

As described above, the depth distribution information 140 is, for example, analysis information about a depth information map. Specifically, the depth distribution information 140 is the depth information histogram described with reference to FIG. 6.

The luminance reliability calculation unit 133 determines whether each piece of data in the depth map information 61 from the depth distribution information 140 belongs to the hill on the left side (hatched portion) or the hill on the right side (dotted portion) for two distributions like those illustrated in FIG. 8, and calculates the following respective values.

(1) Average luminance value (LeftAve) for the 2D image of the pixels belonging to the hill on the left side (hatched portion)
(2) Average luminance value (RightAve) for the 2D image of the pixels belonging to the hill on the right side (dotted portion)
(3) Average luminance difference (DiffAve) for the 2D image between the pixels belonging to the hill on the left side (hatched portion) and the hill on the right side (dotted portion)

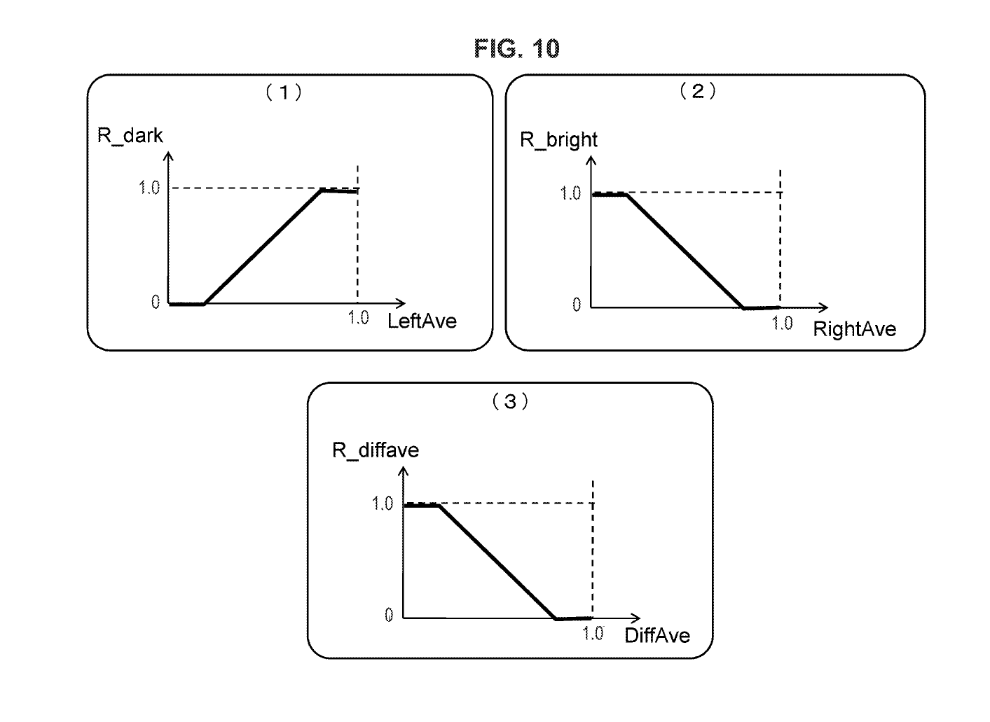

Next, a reliability setting like the characteristics shown in graphs (1) to (3) illustrated in FIG. 10 is performed.

(1) The reliability based on darkness (R_dark) is set to be smaller (closer to 0.0) the smaller the value of the average luminance value (LeftAve) for the 2D image of the pixels belonging to the hill on the left side (hatched portion) is.
(2) The reliability based on brightness (R_bright) is set to be smaller (closer to 0.0) the greater the value of the average luminance value (RightAve) for the 2D image of the pixels belonging to the hill on the right side (dotted portion) is.
(3) The reliability based on difference in brightness (R_diffave) is set to be smaller (closer to 0.0) if the value of the average luminance difference (DiffAve) for the 2D image between the pixels belonging to the hill on the left side (hatched portion) and the hill on the right side (dotted portion) is very large.

The luminance reliability calculation unit 133 sets one of the above three reliabilities (R_dark, R_bright, or R_diffave) as the luminance reliability 143. Alternatively, if a plurality of these three reliabilities are to be used, the luminance reliability 143 can also be calculated and output using the product, a weighted average and the like of these.

The luminance reliability 143 is set at a low reliability when the average luminance for the 2D image of the pixels belonging to each hill of the depth information histogram is excessively low or high.

The luminance reliability 143 is set at a low level if the luminance distribution of the 2D image indicates a special scene (a dark scene, an overexposed scene due to illumination, a backlit scene etc.), and based on this low reliability, the level of conversion processing into a 3D image is suppressed. Consequently, the likelihood of a depth that gives a sense of unease being set in the converted 3D image is reduced, so that side effects can be prevented from standing out as much.

In the above processing example, cases in which the hill on the left side (hatched portion) of the depth information histogram is too dark and cases in which the hill on the right side (dotted portion) is too bright are evaluated as a reliability index. However, the reliability may also be set by evaluating cases in which the hill on the left side (hatched portion) is too bright and the hill on the right side (dotted portion) is too dark as an index, or cases in which all of these are evaluated as an index.

### 3-4. External Block Reliability Calculation Unit Processing

Next, the processing performed by the external block reliability calculation unit 134 in the reliability information generation unit 102 illustrated in FIG. 5 will be described.

As illustrated in FIG. 5, an external block detection signal 55 is input to the external block reliability calculation unit 134. Examples of this external block detection signal 55 may include the following.

Noise amount measurement result
Signal band measurement result
Face detection result
Telop detection result
EPG information
Camera shooting information
Motion detection result

For example, the external block detection signal 55 may be an externally-input detection signal.

Further, the external block detection signal 55 is formed from at least one or more of these signals.

The external block reliability calculation unit 134 generates and outputs an external block correspondence reliability 144 based on these external block detection signals.

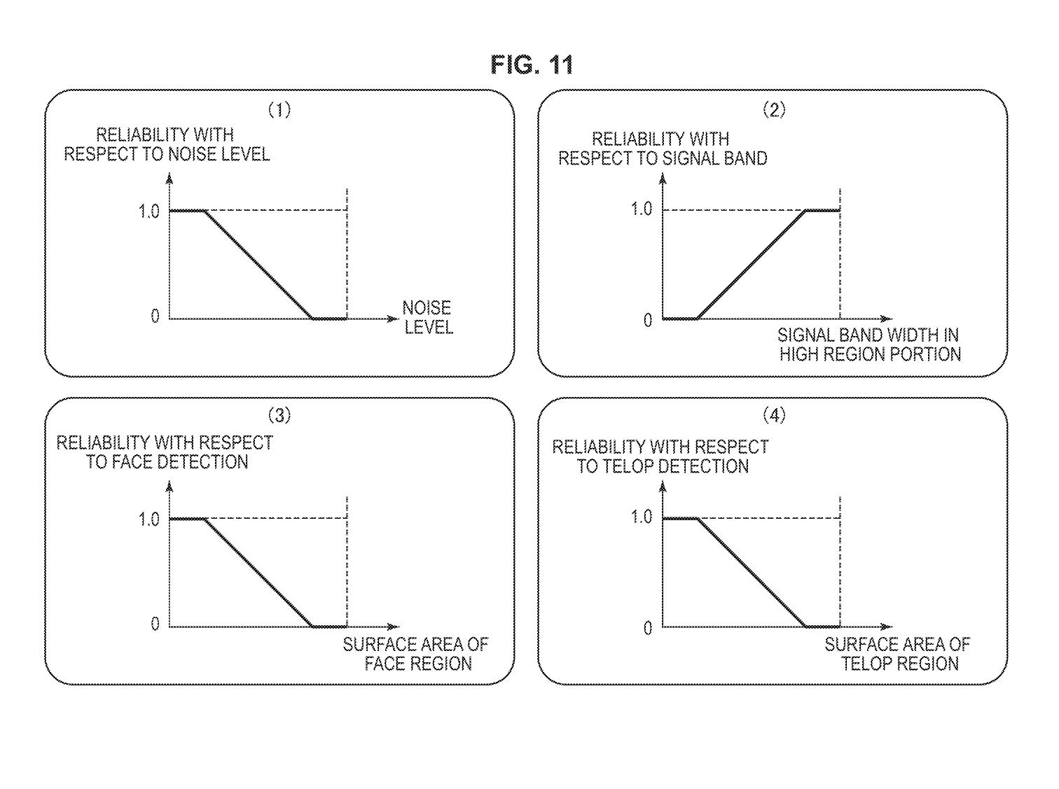

For example, if a noise amount measurement result was input as the external block detection signal 55, as illustrated in FIG. 11(1), the external block reliability calculation unit 134 sets the external block correspondence reliability 144 lower the greater the noise amount is.

Namely, if there is a large amount of noise, since side effects such as a mistaken depth setting in the conversion into a 3D image based on a 2D image tend to stand out, the reliability is set to a low level in order to suppress how much the depth information is reflected in the conversion into a 3D image.

If a signal band measurement result was input as the external block detection signal 55, for example, as illustrated in FIG. 11(2), the external block reliability calculation unit 134 sets the reliability higher the higher the band distribution region is.

This is performed to increase the reliability, as it is easier to estimate the depth map information based on frequency analysis when a scene band distribution extends to a high region.

Further, if a face detection result was input as the external block detection signal 55, as illustrated in FIG. 11(3), the external block reliability calculation unit 134 generates and outputs an external block correspondence reliability 144 in which reliability is set lower the greater the surface area of the face region.

In addition, if a telop detection result was input as the external block detection signal 55, as illustrated in FIG. 11(4), the external block reliability calculation unit 134 generates and outputs an external block correspondence reliability 144 in which reliability is set lower the greater the surface area of the telop region.

For a face region and a telop region, since it is more difficult to estimate the depth map information based on frequency analysis, if these regions are large, the occurrence of side effects is suppressed by setting the reliability to a low level to reduce how much the depth information is reflected in the conversion into a 3D image.

Still further, if EPG information was input as the external block detection signal 55, the external block reliability calculation unit 134 determines whether a video scene is a program category (drama, movie, animal, nature) for which an estimation of the depth map information based on frequency analysis tends to be correct, and controls so that the reliability is set higher if the video scene is a program category (drama, movie, animal, nature) for which an estimation of the depth map information tends to be correct.

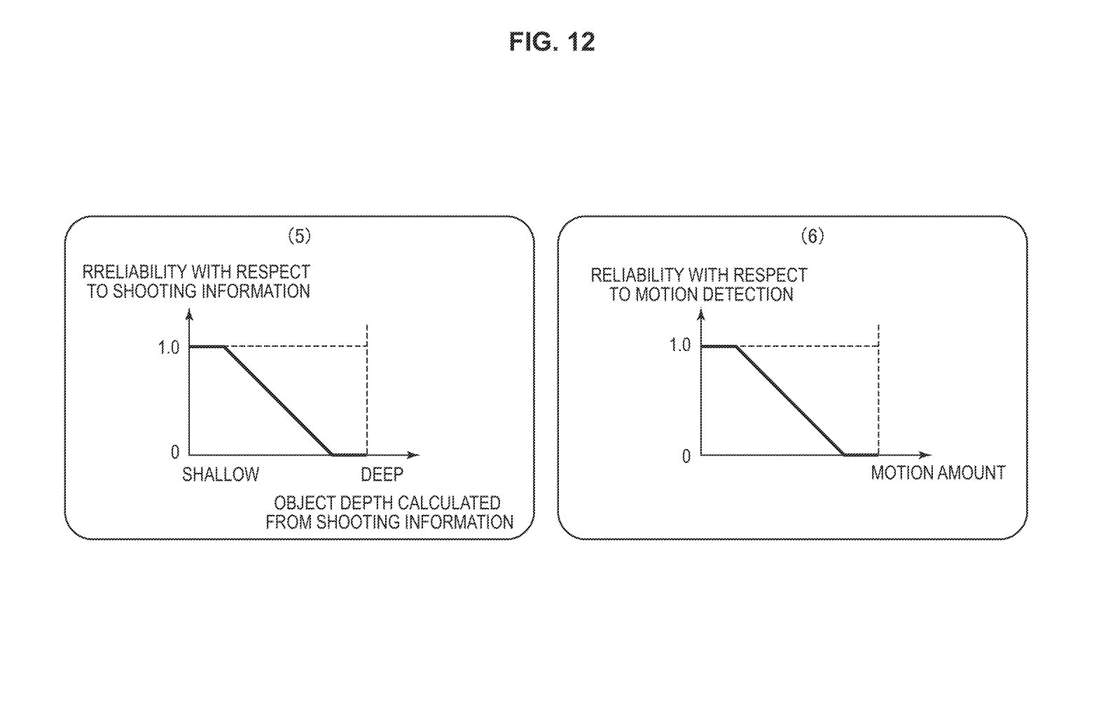

Moreover, if camera shooting information was input as the external block detection signal 55, the external block reliability calculation unit 134 outputs an external block correspondence reliability 144 in which the reliability is set to a high level if, as illustrated in FIG. 12(5), the depth of field calculated (estimated) from information relevant to the depth of field (lens focal length, object distance, F value, permissible circle of confusion etc.) is shallow.

This is because if the depth of field is shallow, it is easier to estimate the depth map information based on frequency analysis, and it is easier to feel the sense of depth in the 3D image.

Further, if a motion detection result was input as the external block detection signal 55, as illustrated in FIG. 12(6), the external block reliability calculation unit 134 outputs an external block correspondence reliability 144 in which reliability is set lower the greater the motion amount is.

This is to control so that the reliability is at a low level due to reasons such as it being difficult to obtain a sense of depth for a moving object that is blurry or is moving quickly.

Among the above-described plurality of reliabilities, the external block reliability calculation unit 134 can output any of them as the external block correspondence reliability 144, and can even combine a plurality of them.

When combining a plurality of these reliabilities, the external block correspondence reliability 144 may be calculated and output using the product, a weighted average and the like of the plurality of reliabilities.

Thus, the external block reliability calculation unit 134 illustrated in FIG. 5 controls side effects such as the occurrence of a sense of unease in depth that occur in 2D to 3D conversion, and calculates and outputs the external block correspondence reliability 144 for promoting a natural sense of depth in a 3D image based on various external block detection signals 55.

### 3-5. Reliability Integration Unit Processing

Next, the processing performed by the reliability integration unit 135 illustrated in FIG. 5 will be described.

The reliability integration unit 135 illustrated in FIG. 5 inputs a plurality of information reliabilities, including the statistical information reliability 141 generated by the statistical information reliability calculation unit 131, the spatial distribution reliability 142 generated by the spatial distribution reliability calculation unit 132, the luminance reliability 143 generated by the luminance reliability calculation unit 133, and the external block reliability 144 generated by the external block reliability calculation unit 134.

The reliability integration unit 135 selects one of the plurality of input reliabilities, sets the selected reliability as the depth map information reliability 62 to be output, and outputs the set reliability.

Alternatively, the reliability integration unit 135 calculates and outputs the depth map information reliability 62 by combining a plurality of these reliabilities.

When combining a plurality of these reliabilities to calculate the depth map information reliability 62, the depth map information reliability 62 may be calculated using the product, a weighted average and the like of the plurality of reliabilities.

### 4. Configuration and Processing of the Depth Map Information Correction Unit

Next, the configuration and processing of the depth map information correction unit 103 in the image processing apparatus 100 illustrated in FIG. 1 will be described.

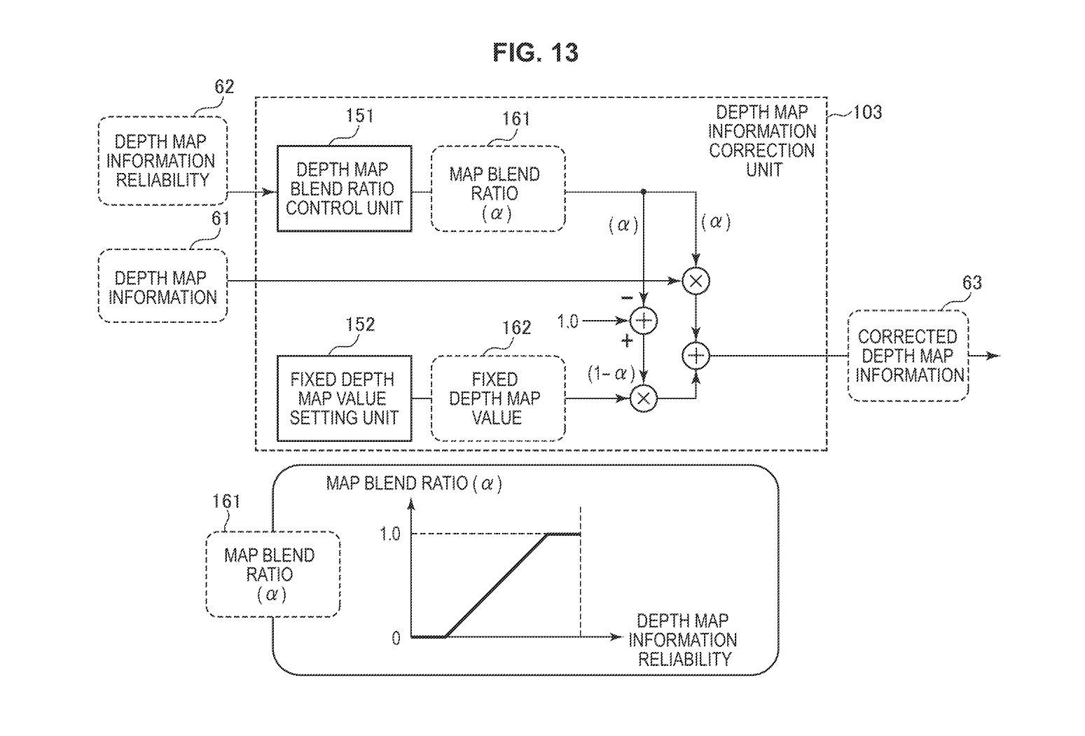

FIG. 13 illustrates a configuration example of the depth map information correction unit 103.

The depth map information correction unit 103 has a depth map blend ratio control unit 151, a fixed depth map value setting unit 152, and two adders and multipliers.

As illustrated in FIG. 1, the depth map information correction unit 103 inputs various information, such as the depth map information 61 generated by the depth map information estimation unit 101 and the depth map information reliability 62.

The depth map blend ratio control unit 151 in the depth map information correction unit 103 illustrated in FIG. 13 generates and outputs a depth map blend ratio (α) 161 based on the input depth map information reliability 62.

The depth map blend ratio (α) 161 is a map blend ratio for performing weighted average processing of the following two maps.

(1) The input depth map information 61 (Freq_Depth), and
(2) A fixed depth map value 162 (Fix_Depth) output from the fixed depth map value setting unit 152.

The fixed depth map value 162 (Fix_Depth) output from the fixed depth map value setting unit 152 is a depth map in which the depth value is set as a fixed value.

The depth map blend ratio control unit 151 calculates and outputs the map blend ratio of predetermined pixel region units, for example, as a blend ratio of respective pixel units.

The depth map blend ratio control unit 151 sets the depth map blend ratio (α) 161 in a manner like the graph in the lower portion of FIG. 13.

In the graph in the lower portion of FIG. 13, the horizontal axis represents the depth map information reliability 62 setting, and the vertical axis represents the depth map blend ratio (α) 161 setting.

The map blend ratio (α=0 to 1) is set based on the value (0 to 1) of the depth map information reliability.

The greater (closer to 1) the value of the depth map information reliability is, the greater (closer to 1) the value of the map blend ratio (α) that is set, and the smaller (closer to 0) the value of the depth map information reliability is, the smaller (closer to 0) the value of the map blend ratio (α) that is set.

The depth map blend ratio control unit 151 sets and outputs the depth map blend ratio (α) 161 for each pixel unit based on the graph in the lower portion of FIG. 13.

The depth map information correction unit 103 determines and outputs corrected depth map information 63 (Rev_Depth) by performing the weighted average processing shown in the below formula based on this map blend ratio (α).

Rev_Depth=α×(Freq_Depth)+(1.0−α)×(Fix_Depth)

Namely, in a region where the depth map information reliability value is large (close to 1), the map blend ratio (α) is set to a large value (close to 1), and a corrected depth map information 63 (Rev_Depth) that largely reflects the input depth map information 61 (Freq_Depth) is calculated based on a weighted average in which the weighting of the set value of the input depth map information 61 (Freq_Depth) is set to be greater than the fixed depth map value (Fix_Depth).

On the other hand, in a region where the depth map information reliability value is small (close to 0), the map blend ratio (α) is set to a small value (close to 0), and a corrected depth map information 63 (Rev_Depth) that largely reflects the fixed depth map value (Fix_Depth) is calculated based on a weighted average in which the weighting of the set value of the input depth map information 61 (Freq_Depth) is set to be smaller than the fixed depth map value (Fix_Depth).

Thus, based on this weight average processing, if the depth map information reliability 62 is a small reliability, the weighting of the fixed depth map value 162 (Fix_Depth) increases, which means that the dynamic range of the depth value in the corrected depth map information (Rev_Depth) 63 decreases. Since this also causes the range of the parallax distribution in the 3D image generated by the subsequent 3D image generation unit 104 to narrow, there is the effect of a weakening (suppression of side effects) of the sense of depth.

On the other hand, if the depth map information reliability 62 is a large reliability, conversely, the range of the parallax distribution in the 3D image generated by the subsequent 3D image generation unit 104 widens, so that there is the effect of a strengthening of the sense of depth.

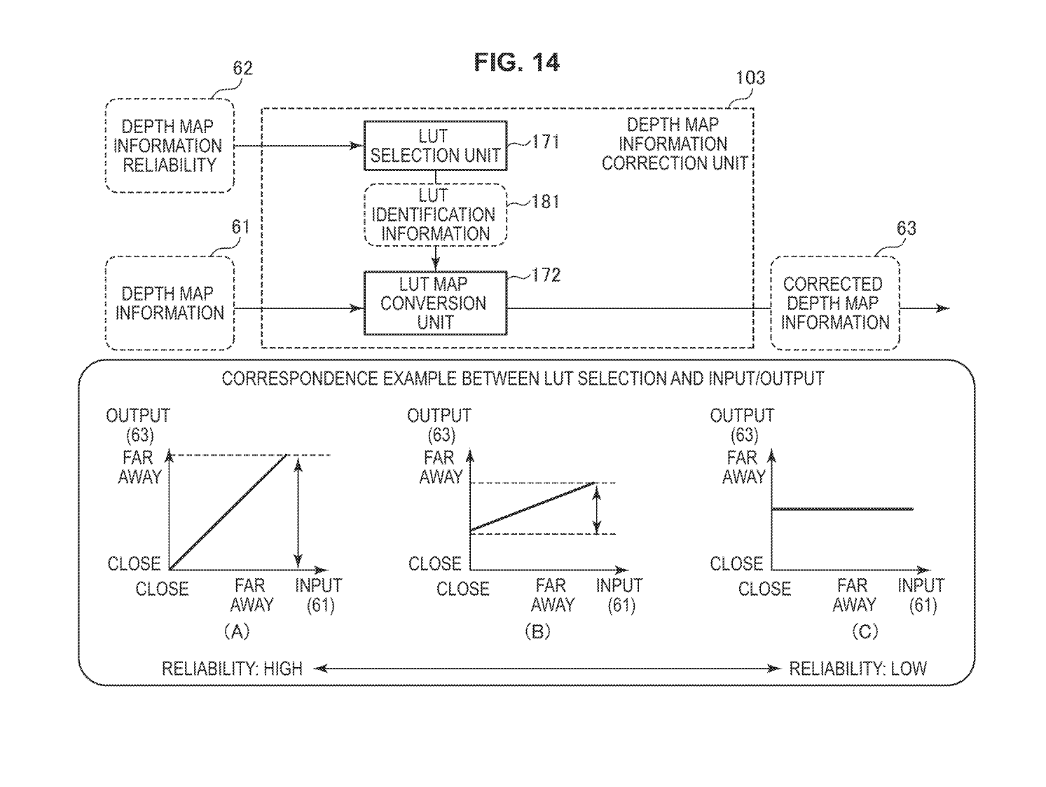

FIG. 14 illustrates another configuration example of the inner configuration of the depth map information correction unit 103.

The depth map information correction unit 103 illustrated in FIG. 14 has a LUT selection unit 171 and a LUT map conversion unit 172.

The LUT selection unit 171 generates and outputs LUT identification information 181 for selecting an input/output correspondence table based on the input depth map information reliability 62 from among a plurality of LUTs (A), (B), and (C) illustrated in the lower portion of FIG. 14 that have a different input/output characteristic.

The LUTs (A), (B), and (C) illustrated in the lower portion of FIG. 14 are tables having the following input/output correspondence relationship.

In the LUTs (A), (B), and (C) illustrated in the lower portion of FIG. 14, the horizontal axis represents a depth value as a setting value of the depth map information 61 generated by the depth map information estimation unit 101, and the vertical axis represents a depth value as a setting value of the corrected depth map information 63 output based on the correction processing performed in the depth map information correction unit 103.

For example, the LUT in FIG. 14(A) is a LUT in which the input and output values are identical, and the setting value of the depth map information 61 generated by the depth map information estimation unit 101 is output without change as the setting value of the corrected depth map information 63.

The LUT in FIG. 14(B) is a LUT in which the width of the output value is set smaller than the width of the input value, and the range of the setting value of the depth map information 61 generated by the depth map information estimation unit 101 is reduced and output as the setting value of the corrected depth map information 63.

The LUT in FIG. 14(C) is a LUT in which a fixed output value is set regardless of the input value, so that a fixed value is output as the setting value of the corrected depth map information 63 without relying on the setting value of the depth map information 61 generated by the depth map information estimation unit 101.

The LUT selection unit 171 generates and outputs the LUT identification information 181 for selecting the LUT illustrated in (A) if the reliability indicated by the input depth map information reliability 62 is large, (C) if the reliability is small, and (B) if the reliability is a medium level.

Thus, if the reliability indicated by the input depth map information reliability 62 is small, since the output dynamic range is reduced, among the plurality of LUTs (A), (B), and (C) illustrated in the lower portion of FIG. 14 that have a different input/output characteristic, (B) or (C) is selected. On the other hand, if the reliability indicated by the input depth map information reliability 62 is large, since the output dynamic range is increased, an LUT that is more closer to (A) than (B) is selected.

The LUT map conversion unit 172 converts the input depth map information 61 based on the input/output characteristic of the LUT that was determined based on the LUT identification information 181, and outputs the corrected depth map information 63.

The LUT characteristic is not limited to being a straight line as illustrated in (A), (B), and (C) of FIG. 14. This characteristic may also be represented by a broken line or a curve, as long as an effect is exhibited in which the dynamic range of the corrected depth map information 63 decreases the smaller the reliability indicated by the depth map information reliability 62 becomes.

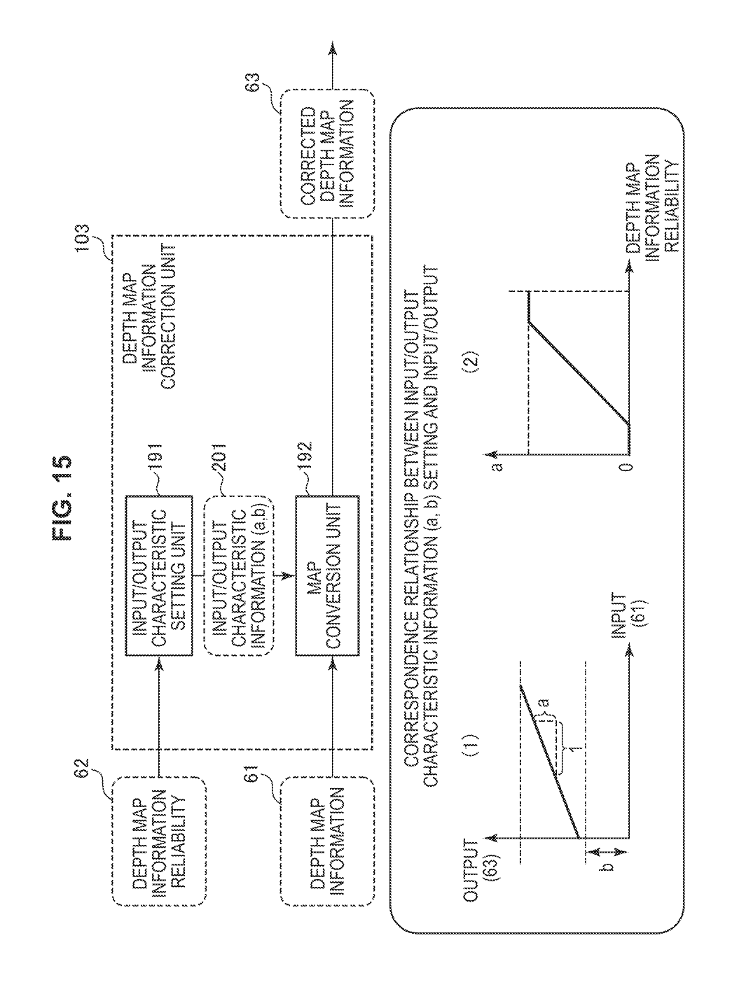

Another configuration example of the depth map information correction unit 103 will now be described with reference to FIG. 15.

The depth map information correction unit 103 illustrated in FIG. 15 has an input/output characteristic setting unit 191 and a map conversion unit 192.

The input/output characteristic setting unit 191 sets and outputs input/output characteristic information (a,b) that includes a parameter (a,b) defining an input/output characteristic like that illustrated in the lower portion of FIG. 15 based on the reliability indicated by the input depth map information reliability 62.

Specifically, as illustrated by graph (2) in the lower portion of FIG. 15, the greater the reliability indicated by the input depth map information reliability 62, the greater the slope a of the characteristic straight line of graph (1) in the lower portion of FIG. 15 becomes. In this case, the method for setting b is arbitrary. For example, b may be a fixed value, or an adjustable parameter set by the user.

Thus, if the reliability indicated by the input depth map information reliability 62 is large, the output dynamic range increases.

Conversely, if the reliability indicated by the depth map information reliability 62 is small, as illustrated by graph (2) in the lower portion of FIG. 15, the parameter a decreases, and the slope a of the characteristic straight line of graph (1) in the lower portion of FIG. 15 decreases. Consequently, the dynamic range of the output corrected depth map information 63 decreases.

In this way, in the map conversion unit 192, input/output characteristic information (a,b) 201 that includes the parameter (a,b) set by the input/output characteristic setting unit 191 is input, and based on the following conversion formula, the input depth map information (Freq_Depth) 61 is converted into corrected depth map information (Rev_Depth) 63, which is then output.

Rev_Depth=α×(Freq_Depth)+b

The parameter (a,b) generated by the input/output characteristic setting unit 191 is not limited to being a straight line like the graph in FIG. 15. This characteristic may also be represented by a broken line or a curve, as long as an effect is exhibited in which the dynamic range of the corrected depth map information 63 decreases the smaller the reliability indicated by the depth map information reliability 62 becomes.

### 5. Processing of the 3D Image Generation Unit

Lastly, the processing performed by the 3D image generation unit 104 in the image processing apparatus 100 illustrated in FIG. 1 will be described.

In the 3D image generation unit 104, the corrected depth map information 63 generated by the depth map information correction unit 103 and the 2D image signal 50 are input. 2D to 3D conversion processing employing the corrected depth map information 63 is performed on the input 2D image signal 50 to generate the 3D image signal 70 formed from an image for a left eye (L image) and an image for a right eye (R image), which are images for three-dimensional (3D) image display.

This 2D to 3D conversion processing can be executed as, for example, processing that uses the method described in Y. J. Jeong, Y. Kawk, Y. Han, Y. J. Jun, and D. Park, “Depth-image-based rendering (DIBR) using disocclusion area restoration,” Proc. of SID, 2009 or the like.

Specifically, the corrected depth map information is converted into parallax information to generate the 3D image signal 70 formed from an image for a left eye (L image) and an image for a right eye (R image) in which a parallax is set in the 2D image signal 50 based on depth.

The method for generating a 3D image from the 2D image by applying depth map information is not limited to the method described in the above publication. Various methods have been proposed. Further, the 3D image generation unit 104 is not limited to the method described in the above publication, and may apply various methods.

### 6. Flow and Effects of the Overall Processing of the Image Processing Apparatus

As described above, first, the image processing apparatus according to the present disclosure analyzes the frequency of an image region with the depth map information estimation unit 101 as described with reference to FIG. 2, and then sets depth information based on the share of the middle-low region component.

Namely, depth map information 61 is generated by setting the depth value based on the share of the middle-low region component, in which the depth value indicates a deep (far away) value if the middle-low region component share is high, and a near (close) value if the middle-low region component share is low.

Based on this method, the following effects can be obtained, for example.

For example, there is an effect of suppressing the side effect in which edge portions with a high contrast, such as nightscape neon, jump out too near.

Further, there is an effect of suppressing an unnatural sense of depth of a 3D image generated when a region with a comparatively low contrast (an animal coat, the wrinkles on people's skin etc.) that are in-focus by the camera, are mistakenly estimated as being further away.

In addition, for scenes having a shallow depth of field (a scene in which a foreground object is in-focus and the background is out of focus), a 3D image can be generated that has a sense of depth, while for scenes that cause mistaken estimation, such as a pan focus scene with a deep depth of field, an unnatural sense of depth in the 3D image can be suppressed. Consequently, there is an effect of reducing the burden on a viewer's eyes while maintaining a stereoscopic effect for effective scenes.

The reliability information generation unit 102 in the image processing apparatus according to the present disclosure is configured to calculate a reliability of the depth map information 61 by applying information such as statistical information about the setting value of a depth information map, spatial distribution information about the setting value of a depth information map, luminance distribution information about a 2D image, and various information obtained from an external block.

Further, the depth map information correction unit 103 executes correction processing of the depth map information 61 generated by the depth map information estimation unit 101 based on the depth map information reliability 62 generated by the reliability information generation unit 102.

Specifically, for example, the correction processing of the depth map information 61 is executed by applying any of:

(1) blend processing of depth map information 61, in which a blend ratio (α) has been applied based on a reliability, and a fixed depth map value (weighted average),
(2) correction processing in which a LUT is selected from among a plurality of LUTs that define an input/output correspondence relationship based on a reliability, and the selected LUT is applied, and
(3) correction processing in which a parameter (a,b) defining an input/output characteristic is set based on a reliability, and the set parameter is applied.

The correction processing of the depth map information 61 is executed based on a reliability calculated by executing a reliability calculation of depth map information based on such various elements.

Based on these processes, the reliability of a setting value of depth map information can be more reliably grasped, and precise correction that is based on this reliability is realized.

### 7. Summary of the Configuration of the Present Disclosure

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image processing apparatus including:

a depth map information estimation unit configured to estimate a depth in region units of a two-dimensional image and generate depth map information in which a depth estimation value in region units of a two-dimensional image is set;

a reliability information generation unit configured to generate a depth map information reliability by determining a reliability of the depth value set in the depth map information;

a depth map information correction unit configured to generate corrected depth map information by correcting the depth map information based on the depth map information reliability; and

a 3D image generation unit configured to generate from the two-dimensional image an image for a left eye (L image) and an image for a right eye (R image) to be applied in a three-dimensional image display by applying the corrected depth map information,

wherein the depth map information estimation unit is configured to

calculate a middle-low region component energy share from a middle-low region component energy and an AC component energy in region units by performing a frequency component analysis in region units of the two-dimensional image, and

generate depth map information in which a depth estimation value is set based on a value of the calculated middle-low region component energy share.

(2) The image processing apparatus according to (1), wherein the depth map information estimation unit is configured to generate depth map information in which

a depth estimation value indicating a deep (far away) position is set for a region in which the middle-low region component energy share is large, and

a depth estimation value indicating a near (close) position is set for a region in which the middle-low region component energy share is small.

(3) The image processing apparatus according to (1) or (2), wherein the depth map information estimation unit is configured to generate depth map information in which a depth estimation value is set based on a value of the calculated middle-low region component energy share by calculating the middle-low region component energy share from the middle-low region component energy and the AC component energy in region units based on the following formula.

Middle-low region component energy share=(Middle-low region component energy)/(AC component energy)

(4) The image processing apparatus according to any one of claims (1) to (3), wherein the reliability information generation unit is configured to generate a statistical information reliability calculated by applying peak position information in a depth information histogram, which is frequency distribution information about depth values in the depth map information.

(5) The image processing apparatus according to any one of claims (1) to (4), wherein the reliability information generation unit is configured to calculate a frequency ratio (MF/PF) between a frequency (PF) of a peak value in a depth information histogram, which is frequency distribution information about depth values in the depth map information, and a frequency (MF) of a local minimum in the depth information histogram, and generate a statistical information reliability based on the frequency ratio (MF/PF).

(6) The image processing apparatus according to any one of claims (1) to (5), wherein the reliability information generation unit is configured to generate a spatial distribution reliability calculated by applying difference information about depth values in predetermined region units of the depth map information.

(7) The image processing apparatus according to any one of claims (1) to (6), wherein the reliability information generation unit is configured to generate a luminance reliability, which is a reliability based on a luminance of the two-dimensional image.

(8) The image processing apparatus according to any one of claims (1) to (7), wherein the reliability information generation unit is configured to generate an external block correspondence reliability by applying an externally-input external block detection signal.

(9) The image processing apparatus according to (8),

wherein the external block detection signal is at least one of a noise amount measurement result, a signal band measurement result, a face detection result, a telop detection result, EPG information, camera shooting information, or a motion detection result, and

wherein the reliability information generation unit is configured to generate the external block correspondence reliability by applying any of the detection signals.

(10) The image processing apparatus according to any one of claims (1) to (9), wherein the depth map information correction unit is configured to generate corrected depth map information by determining a blend ratio between the depth map information and a fixed depth map that has a fixed value as a depth value based on the depth map information reliability, and executing blend processing between the depth map information and the fixed depth map by applying the determined bland ratio.

(11) The image processing apparatus according to (10), wherein the depth map information correction unit is configured to generate corrected depth map information by executing blend processing which, when the depth map information reliability is high, increases a blend ratio of the depth map information, and when the depth map information reliability is low, decreases a blend ratio of the depth map information.

(12) The image processing apparatus according to any one of claims (1) to (11), wherein the depth map information correction unit is configured to generate corrected depth map information in which a depth value range set in the depth map information is controlled based on the depth map information reliability.

(13) The image processing apparatus according to (12), wherein the depth map information correction unit is configured to generate corrected depth map information by executing a control which, when the depth map information reliability is high, decreases a contraction width of a depth value range set in the depth map information, and when the depth map information reliability is low, increases a contraction width of a depth value range set in the depth map information.

A method of the processing that is executed in the apparatus and a program for executing the processing are included in the configuration of the present disclosure.

The series of processes described in the present disclosure can be executed by hardware, software, or a combination of the hardware and the software. When the series of processes is executed by the software, a program having a recorded processing sequence may be installed in a memory in a computer embedded in dedicated hardware and may be executed or may be installed in a general-purpose computer in which various processing can be executed and may be executed. For example, the program may be recorded previously in a recording medium. The program may be installed from the recording medium to the computer or the program may be received through a network such as a local area network (LAN) and the Internet and may be installed in the recording medium such as an embedded hard disk.

The various processing described in the present disclosure may be executed temporally according to the order described or may be executed in parallel or individually according to the processing capability of an apparatus executing the processing or the necessity. In the present disclosure, a system has a logical set configuration of a plurality of apparatuses and each apparatus may not be provided in the same casing.

According to the configuration of an embodiment of the present disclosure, an apparatus and method are realized for generating a 3D image that applies a highly precise depth value by performing a high-precision depth estimation from a two-dimensional image.

Specifically, a depth map information estimation unit generates depth map information in which a depth estimation value in region units of a two-dimensional image is set. A reliability of the depth value set in the depth map information is determined. The depth map information is corrected based on the reliability to generate corrected depth map information. An image for a left eye (L image) and an image for a right eye (R image) to be applied in a three-dimensional image display are generated from the two-dimensional image by applying the corrected depth map information. The depth map information estimation unit calculates a middle-low region component energy share from a middle-low region component energy and an AC component energy in region units, and generates depth map information in which a depth estimation value is set based on a value of the calculated middle-low region component energy share.

According to this configuration, an apparatus and method are realized for generating a 3D image that applies a highly precise depth value by performing a high-precision depth estimation from a two-dimensional image.

The present disclosure contains subject matter related to that disclosed in Japanese Priority Patent Application JP 2012-033125 filed in the Japan Patent Office on Feb. 17, 2012, the entire content of which is hereby incorporated by reference.

What is claimed is:

1. An image processing apparatus comprising:
a depth map information estimation unit configured to estimate a depth in region units of a two-dimensional image and generate depth map information in which a depth estimation value in region units of a two-dimensional image is set;
a reliability information generation unit configured to generate a depth map information reliability by determining a reliability of the depth value set in the depth map information;
a depth map information correction unit configured to generate corrected depth map information by correcting the depth map information based on the depth map information reliability; and
a 3D image generation unit configured to generate from the two-dimensional image an image for a left eye (L image) and an image for a right eye (R image) to be applied in a three-dimensional image display by applying the corrected depth map information,
wherein the depth map information estimation unit is configured to
calculate a middle-low region component energy share from a middle-low region component energy and an AC component energy in region units by performing a frequency component analysis in region units of the two-dimensional image, and
generate depth map information in which a depth estimation value is set based on a value of the calculated middle-low region component energy share.

2. The image processing apparatus according to claim 1, wherein the depth map information estimation unit is configured to generate depth map information in which
a depth estimation value indicating a deep (far away) position is set for a region in which the middle-low region component energy share is large, and
a depth estimation value indicating a near (close) position is set for a region in which the middle-low region component energy share is small.

3. The image processing apparatus according to claim 1, wherein the depth map information estimation unit is configured to generate depth map information in which a depth estimation value is set based on a value of the calculated middle-low region component energy share by calculating the middle-low region component energy share from the middle-low region component energy and the AC component energy in region units based on the following formula.
Middle-low region component energy share=(Middle-low region component energy)/(AC component energy)

4. The image processing apparatus according to claim 1, wherein the reliability information generation unit is configured to generate a statistical information reliability calculated by applying peak position information in a depth information histogram, which is frequency distribution information about depth values in the depth map information.

5. The image processing apparatus according to claim 1, wherein the reliability information generation unit is configured to calculate a frequency ratio (MF/PF) between a frequency (PF) of a peak value in a depth information histogram, which is frequency distribution information about depth values in the depth map information, and a frequency (MF) of a local minimum in the depth information histogram, and generate a statistical information reliability based on the frequency ratio (MF/PF).

6. The image processing apparatus according to claim 1, wherein the reliability information generation unit is configured to generate a spatial distribution reliability calculated by applying difference information about depth values in predetermined region units of the depth map information.

7. The image processing apparatus according to claim 1, wherein the reliability information generation unit is configured to generate a luminance reliability, which is a reliability based on a luminance of the two-dimensional image.

8. The image processing apparatus according to claim 1, wherein the reliability information generation unit is configured to generate an external block correspondence reliability by applying an externally-input external block detection signal.

9. The image processing apparatus according to claim 8,
wherein the external block detection signal is at least one of a noise amount measurement result, a signal band measurement result, a face detection result, a telop detection result, EPG information, camera shooting information, or a motion detection result, and
wherein the reliability information generation unit is configured to generate the external block correspondence reliability by applying any of the detection signals.

10. The image processing apparatus according to claim 1, wherein the depth map information correction unit is configured to generate corrected depth map information by determining a blend ratio between the depth map information and a fixed depth map that has a fixed value as a depth value based on the depth map information reliability, and executing blend processing between the depth map information and the fixed depth map by applying the determined bland ratio.

11. The image processing apparatus according to claim 10, wherein the depth map information correction unit is configured to generate corrected depth map information by executing blend processing which, when the depth map information reliability is high, increases a blend ratio of the depth map information, and when the depth map information reliability is low, decreases a blend ratio of the depth map information.

12. The image processing apparatus according to claim 1, wherein the depth map information correction unit is configured to generate corrected depth map information in which a depth value range set in the depth map information is controlled based on the depth map information reliability.

13. The image processing apparatus according to claim 12, wherein the depth map information correction unit is configured to generate corrected depth map information by executing a control which, when the depth map information reliability is high, decreases a contraction width of a depth value range set in the depth map information, and when the depth map information reliability is low, increases a contraction width of a depth value range set in the depth map information.

14. An image processing method executed in an image processing apparatus, the method comprising:
estimating with a depth map information estimation unit a depth in region units of a two-dimensional image and generating depth map information in which a depth estimation value in region units of a two-dimensional image is set;
generating with a reliability information generation unit a depth map information reliability by determining a reliability of the depth value set in the depth map f of a two-dimensional image and information;
generating with a depth map information correction unit corrected depth map information by correcting the depth map information based on the depth map information reliability; and
generating with a 3D image generation unit from the two-dimensional image an image for a left eye (L image) and an image for a right eye (R image) to be applied in a three-dimensional image display by applying the corrected depth map information,
wherein in the depth map information estimation step,
a middle-low region component energy share is calculated from a middle-low region component energy and an AC component energy in region units by performing a frequency component analysis in region units of the two-dimensional image, and
depth map information is generated in which a depth estimation value is set based on a value of the calculated middle-low region component energy share.

15. A program which causes an image processing apparatus to execute image processing, wherein the program is configured to:
estimate in a depth map information estimation unit a depth in region units of a two-dimensional image and generate depth map information in which a depth estimation value in region units of a two-dimensional image is set;
generate in a reliability information generation unit a depth map information reliability by determining a reliability of the depth value set in the depth map f of a two-dimensional image and information;
generate in a depth map information correction unit corrected depth map information by correcting the depth map information based on the depth map information reliability; and
generate in a 3D image generation unit from the two-dimensional image an image for a left eye (L image) and an image for a right eye (R image) to be applied in a three-dimensional image display by applying the corrected depth map information,
wherein in the depth map information estimation,
a middle-low region component energy share is calculated from a middle-low region component energy and an AC component energy in region units by performing a frequency component analysis in region units of the two-dimensional image, and
depth map information is generated in which a depth estimation value is set based on a value of the calculated middle-low region component energy share.
